(19) United States
(12) Patent Application Publication
(10) Pub. No.: US 2007/0063071 A1
(43) Pub. Date: Mar. 22, 2007

(54) DEVICE AND METHOD FOR DE-ICING AND WASHING WINDSHIELD OF VEHICLE

(75) Inventors: Ker-She Liang, Taipei (TW); Bor-Shing Lin, Taipei (TW)

Correspondence Address: KIRTON AND MCCONKIE, 60 EAST SOUTH TEMPLE,, SUITE 1800, SALT LAKE CITY, UT, 84111, US

(73) Assignee: PICARD INDUSTRIAL CORPORATION, Taipei (TW)

(21) Appl. No.: 11/465,489

(22) Filed: Aug. 18, 2006

(30) Foreign Application Priority Data
Aug. 18, 2005 (CN) 200510092683.9
Jun. 23, 2006 (CN) 200610093227.0

(51) Int. Cl. B05B 1/10; B60S 1/46

(52) U.S. Cl. 239/284.1; 239/284.2

(57) ABSTRACT

In a de-icing and washing device and method of a vehicle, a heating module is in liquid communication between the main tank and a nozzle. The control module is communicated with the pump, the wiper and the heating module, and operated in an automatic mode for activating the heating module to heat the washing liquid therein and automatically starting the pump when the temperature of the washing liquid in the heating module is ranged from a first preset value to a second preset value. In such manner, the washing liquid in the main tank is introduced into the heating module, heated by the heating module and sprayed through the nozzle.

### FIELD OF THE INVENTION

The present invention relates to a de-icing and washing device, and more particularly to a device for de-icing and washing a windshield of a vehicle. The present invention also relates to a de-icing and washing method for de-icing and washing a windshield of a vehicle.

### BACKGROUND OF THE INVENTION

In frigid zones, moisture attached onto the windshield of a vehicle is readily frozen into ice. The thick ice would obstruct the sight of the driver and thus threaten driving safety. In addition, contaminants such as dust, rainwater, mud and/or insects may be stuck on the windshield of the vehicle, and cannot be easily removed.

For de-icing and washing the windshield, warm or hot washing liquid is sprayed onto the windshield to melt the ice and facilitate the removal of the contaminants. Please refer to U.S. Pat. No. 5,118,040, which is entitled “Apparatus for washing the window glass of a vehicle” and incorporated herein for reference. The de-icing and washing system, as shown in FIG. 1, comprises a main tank 1 storing therein the washing liquid, a nozzle 2, a container 4 connected to the main tank 1 through a conduit 3, and a heater 5 disposed in the container 4. By making the inlet of the container 4 at a lower level than the outlet of the main tank 1, the washing liquid tends to continuously flow from the main tank 1 to the container 4 due to gravity. During the operation of the vehicle, the heater 5 keeps heating the washing liquid in the container 4. When the temperature reaches a preset level, e.g. 70 degrees Celsius, the heater 5 is suspended. When the driver would like to have the windshield washed and/or de-iced, a pump 10 is activated to pump some washing liquid from the main tank 1 into the container 4. Due to the pumping force, the heated washing liquid in the container 4 is then sprayed out through the nozzle 2. With the heated washing liquid sprayed over the windshield, the ice on the windshield can be melted and the contaminants can be solved or suspended in the liquid. In the prior art, the de-icing and washing function is activated along with the actuation of a wiper. In other words, whenever the driver triggers the wiper switch to de-ice or wash the windshield, the wiper waves as well. However, such operation is disadvantageous if the wiper is frozen onto the windshield before the supply of the heated liquid. The actuation of the wiper under this condition is likely to damage the wiper. Moreover, since the spray of the washing liquid is activated via the existing wiper switch, there are only two power states, i.e. ON and OFF.

Another de-icing and washing system is shown in FIG. 2, which is developed and commercially available from Micro-Heat Inc., New York, USA. The de-icing and washing system of FIG. 2 comprises a main tank 1 and a nozzle 2 similar to those of FIG. 1 and sharing similar numeral references, and in addition, comprises a heating unit 40 and an exclusive pump 11. The heating unit 40 is equipped with a control circuit 400 and connected to the main tank 1 through two conduits 31 and 32. The heating unit 40 is capable of receiving and heating washing liquid from the main tank. When the driver would like to have the windshield washed and/or de-iced, a control command is issued by triggering a switch and processed by the control circuit 400 to activate the pump 11, thereby the heated washing liquid can be sprayed onto the windshield through the conduit 32. On the other hand, in a case that the de-icing function is not required, the heating function of the heating unit 40 and the exclusive pump 11 are disabled by the control circuit 400. Meanwhile, the pump 10 for the main tank 1 is activated to send the unheated washing liquid from the main tank 1 to the disabled heating unit 40 through the conduit 31 and then have the unheated washing liquid sprayed over the windshield via the nozzle 2. In this case, the de-icing and washing system offers independent control circuit to activate/deactivate the de-icing and washing function, the extra pump 11 and complicated piping system need significant cost and laboring.

### SUMMARY OF THE INVENTION

The present invention provides de-icing and washing device and method for de-icing and washing a windshield of a vehicle in a selective mode.

The present invention also relates to de-icing and washing device and method allowing the de-icing and washing function of a windshield of a vehicle to be performed independently from the actuation of a wiper without complicated piping design and any extra pump.

In accordance to an aspect of the present invention, there is provided a de-icing and washing device of a vehicle. The vehicle has a main tank storing therein a washing liquid, a pump and a nozzle. The de-icing and washing device comprises a heating module and a control module. The heating module is in liquid communication between the main tank and the nozzle. The control module is communicated with the pump and the heating module, and operated in an automatic mode for activating the heating module to heat the washing liquid therein and automatically starting the pump when the temperature of the washing liquid in the heating module is ranged from a first preset value to a second preset value. In such manner, the washing liquid in the main tank is introduced into the heating module, heated by the heating module and sprayed through the nozzle.

In an embodiment, the heating module comprises a heating pipe for heating the washing liquid and a temperature sensor for monitoring the temperature of the washing liquid in the heating pipe.

In an embodiment, the control module comprises a control box and a main control circuit. The control box is disposed in the vicinity of the driver's seat and including an operation mode switching button thereon. The main control circuit is electrically connected to the operation mode switching button, the control module and the pump, and operated in the automatic mode when the operation mode switching button is triggered.

In an embodiment, the heating module is automatically activated to heat the washing liquid therein when the temperature of the washing liquid in the heating module is less than the first preset value.

In an embodiment, the control module further comprises a sound generator. A warning sound is automatically emitted from the sound generator and the heating operation of the heating module is stopped when the temperature of the washing liquid in the heating module is greater than the second preset value.

In an embodiment, the control module further comprises a water status indicator, an automatic mode indicator and a battery status indicator.

In an embodiment, the control module is operated in a manual mode when the operation mode switching button is triggered once more. The control module further comprises a spraying button actuated to start the pump when the temperature of the washing liquid in the heating module is ranged from the first preset value to the second preset value such that the washing liquid in the main tank is introduced into the heating module, heated by the heating module and sprayed through the nozzle.

Preferably, the control module is communicated with the pump and the heating module via wired signal transmission or wireless signal transmission.

In an embodiment, the de-icing and washing device further comprises a filter and a one-way valve. The filter is arranged between the main tank and the heating module for removing contaminate from the washing liquid of the main tank. The one-way valve is arranged between the main tank and the heating module for preventing the washing liquid from flowing back.

In accordance with another aspect of the present invention, there is provided a method for de-icing and washing a windshield of a vehicle. The vehicle has a main tank storing therein a washing liquid, a pump, a nozzle, a heating module and a control module. Firstly, in response to a triggering operation of an actuating button, the heating module is activating to heat the washing liquid therein. Then, the pump is started when the temperature of the washing liquid in the heating module is ranged from a first preset value to a second preset value, so that the washing liquid in the main tank is introduced into the heating module, heated by the heating module and sprayed through the nozzle.

In an embodiment, the method further comprises a step of automatically activating the heating module to heat the washing liquid therein when the temperature of the washing liquid in the heating module is less than the first preset value.

In an embodiment, the method further comprises a step of automatically emitting a warning sound and stopping heating operation of the heating module when the temperature of the washing liquid in the heating module is greater than the second preset value.

In an embodiment, the method further comprises a step of emitting a warning sound and stopping heating operation when the output voltage of the battery is lower than a first threshold voltage.

In an embodiment, the warning sound is ended when the output voltage of the battery is increased to a second threshold voltage, which is larger than the first threshold voltage.

In an embodiment, the pump is automatically started when the actuating button is triggered to enter an automatic mode.

In an embodiment, when the actuating button is triggered to enter a manual mode, the pump is manually started by pushing a spraying button.

In accordance with another aspect of the present invention, there is provided a de-icing and washing device of a vehicle. The vehicle has a wiper module, a main tank storing therein a washing liquid, a pump and a nozzle. The de-icing and washing device comprises a heating module and a control module. The heating module is in liquid communication between the main tank and the nozzle. The control module is communicated with the wiper module, the pump and the heating module. The control module suspends the function of the wiper module in a specified condition but the heating module is activated to heat the washing liquid therein, so that the washing liquid in the main tank is introduced into the heating module, heated by the heating module and sprayed through the nozzle.

In accordance with another aspect of the present invention, there is provided a de-icing and washing device of a vehicle. The vehicle has a wiper module, a main tank storing therein a washing liquid, a pump and a nozzle. The de-icing and washing device comprises a heating module and a switching module. The heating module is in liquid communication between the main tank and the nozzle. The switching module is electrically connected to the wiper module or the pump and actuated to suspend the function of the wiper module but the heating module is activated to heat the washing liquid therein, so that the washing liquid in the main tank is introduced into the heating module, heated by the heating module and sprayed through the nozzle.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a schematic architecture of a conventional de-icing and washing system;

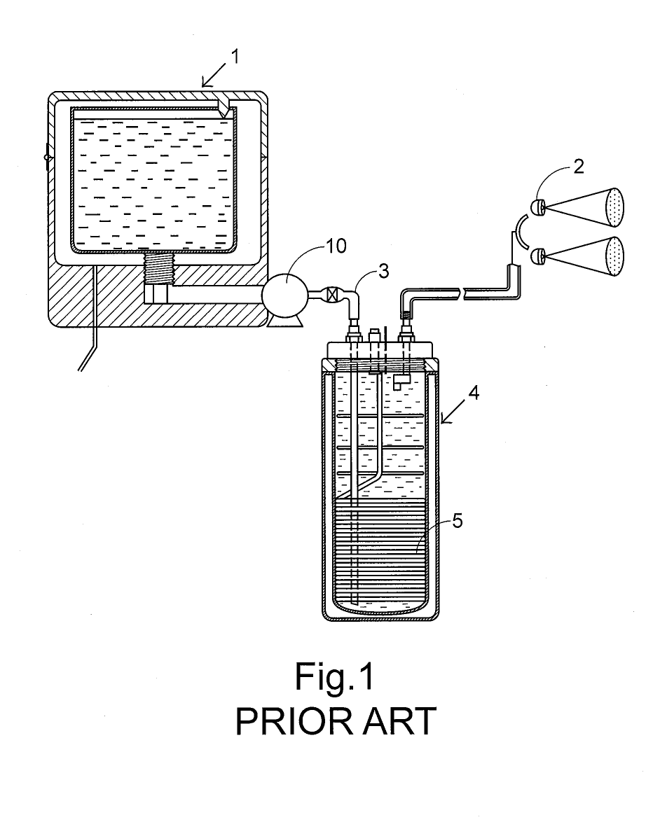

FIG. 2 is a schematic architecture of another conventional de-icing and washing system;

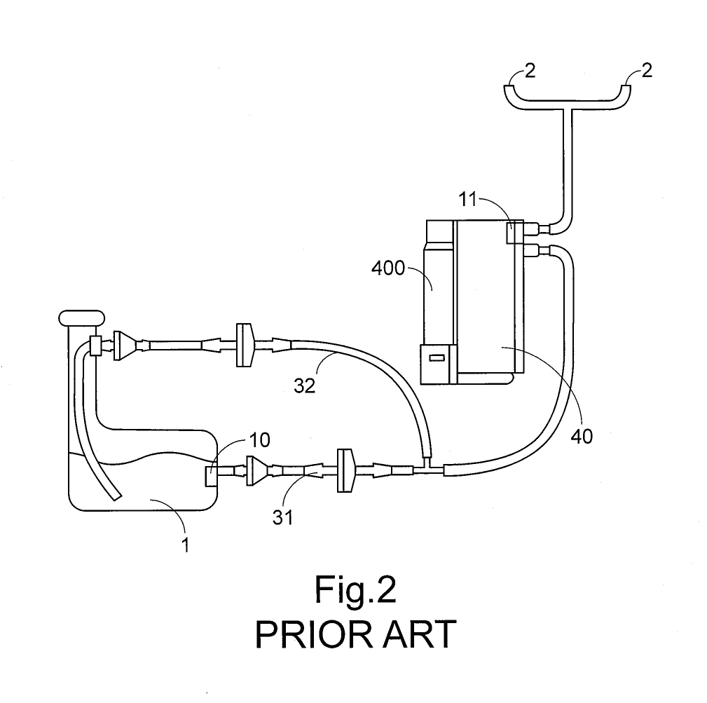

FIG. 3 is a schematic architecture of a de-icing and washing device according to an embodiment of the present invention;

FIG. 4 is a scheme illustrating the switching of selective modes in sequence according to a de-icing and washing method of the present invention by triggering a switch;

FIG. 5 is a flowchart illustrating an embodiment of an automatically controlled de-icing and washing method according to the present invention;

FIG. 6 is a flowchart illustrating an embodiment of a manually controlled de-icing and washing method according to the present invention;

FIG. 7 is a flowchart illustrating a further embodiment of a de-icing and washing method according to the present invention, wherein the power supply to the wiper motor is optionally suspended;

FIG. 8 is a schematic architecture illustrating a de-icing and washing device according to a further embodiment of the present invention;

FIG. 9 is a flowchart illustrating yet another embodiment of a de-icing and washing method according to the present invention, wherein the heating of the washing liquid is optionally disabled; and

FIG. 10 is a schematic architecture illustrating a de-icing and washing device according to a yet another embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the scope of the description.

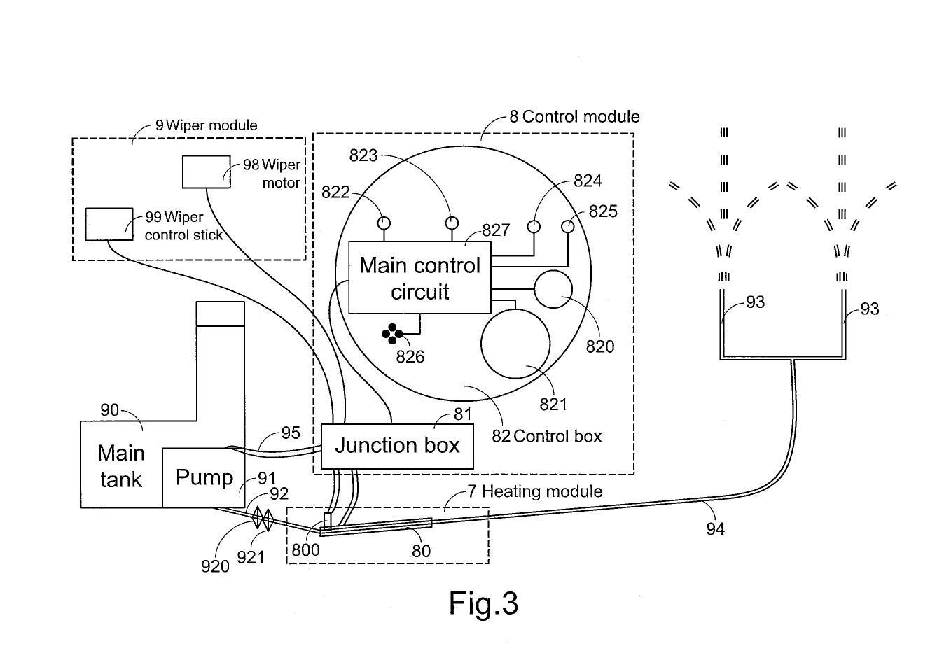

Referring to FIG. 3, a schematic architecture of a de-icing and washing device according to a preferred embodiment of the present invention is shown. The de-icing and washing device of the present invention is applied to for example a vehicle possibly used in frigid zones. The vehicle has been installed therein a main tank 90, a pump 91 in the lower portion of the main tank 90, and a wiper module 9 including a wiper motor 98 and a wiper control stick 99. The main tank 90 has been stored therein a washing liquid. When the pump 91 is started, the washing liquid is forced to flow through the conduits 92, 94 and spray over the windshield through the nozzle 93. As previously described, in the conventional de-icing and washing device, the pump 91 is activated by the wiper control stick 99 while the wiper motor 98 is activated to drive the wiper (not shown) to wipe the windshield (not shown).

The de-icing and washing device of the present invention principally comprises a heating module 7, a control module 8 and accessories such as a filter 920 and a one-way valve 921. The filter 920 and the one-way valve 921 are arranged between the main tank 90 and the heating pipe 80 for filtering contaminants from the washing liquid and preventing the washing liquid from flowing back, respectively. The heating module 7 is arranged downstream of the one-way valve 921, and comprises a heating pipe 80 and a temperature sensor 800. In an embodiment, the heating pipe 80 has a capacity of 100 ml. In addition, the heating pipe 80 has a heating mechanism electrically connected to a power supply unit such as a storage battery (not shown) through a junction box 81 of the control module 8, for example. The temperature sensor 800 is also electrically connected to the junction box 81 such that the control module 8 may monitor the temperature of the washing liquid in the heating pipe 80. The pump 91 is also electrically connected to the junction box 81 via a control signal line 95 such that the control module 8 may control operations of the pump 91. Moreover, the wiper motor 98 and the wiper control stick 99 are also electrically connected to the junction box 81 according to the present invention.

The heating pipe 80 is preferably located at a lower position than the main tank 90 such that the washing liquid is introduced into the heating pipe 80 by gravity. In a case that the heating pipe 80 is located at a higher position than the main tank 90 due to space limitation, the pump 91 should be previously started (automatically or manually) to introduce the washing liquid into the heating pipe 80 before the heating operation. Meanwhile, the one-way valve 921 assures that washing liquid in the heating pipe 80 will not flow back even if the main tank 90 is pumped to empty.

For a purpose of providing an operation interface, the control module 8 further comprises a control box 82 electrically connected to the vehicular dashboard or located in the vicinity of the driver's seat. In this embodiment, the control box 82 is communicated with the junction box 81 via a wired signal transmission technology. Alternatively, the control box 82 is wirelessly communicated with the junction box 81 via a wireless interface. The control box 82 comprises an operation mode switching button 820, a spraying button 821, several indicators 822˜825, a sound generator 826 and a main control circuit 827. The operation mode switching button 820 is actuated for selecting one of an automatic operation mode, a manual operation mode and a disabled mode. Examples of the indicators 822˜825 are light emitting diodes (LEDs). The spraying button 821 is activated to spray the washing liquid. The battery status indicator 822 is lit or flashed when the vehicular battery is too low. The water status indicator 823 indicates that the water level of the main tank 90 is insufficient. The automatic mode indicator 824 and the manual mode indicator 825 indicate that the de-icing and washing device is in the automatic operation mode and the manual operation mode, respectively. The sound generator 826 is a buzzer to sound and alert the driver when some abnormal conditions occur, for example there is a low battery or a low water level. An exemplary main control circuit 827 is a micro-controller, which may alternatively be disposed outside the control box 82.

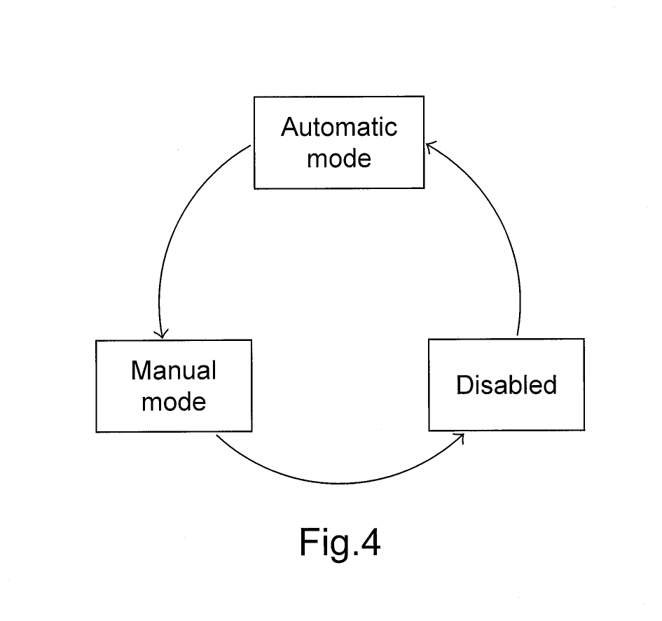

Via the operation mode switching button 820, the automatic operation mode and the manual operation mode of the de-icing and washing device can be selectively and independently enabled and/or disabled for example according to the sequence shown in FIG. 4. In this example, the de-icing and washing device is operated in the automatic mode upon the operation mode switching button 820 is pressed down. If the operation mode switching button 820 is pressed down again, the de-icing and washing device is operated in the manual mode. One more sequential push of the operation mode switching button 820 will power off the de-icing and washing device.

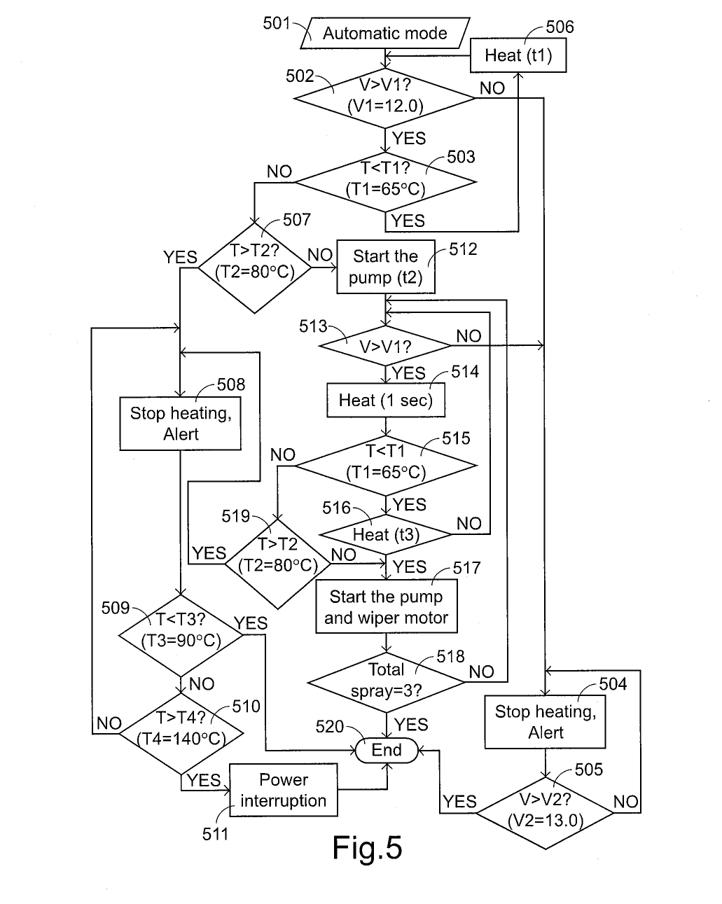

Hereinafter, an embodiment of operating the de-icing and washing device according to the present invention will be illustrated with reference to the flowchart of FIG. 5.

First of all, by pushing the operation mode switching button 820, the automatic mode is entered (Step 501). If the battery voltage V checked by the main control circuit 827 is greater than a first threshold voltage V1 such as 12.0 volts (Step 502). Otherwise, in response to the control signal from the main control circuit 827, the related operations are stopped, the battery status indicator 822 is turned on, and the buzzer 826 emits warning sounds to alert the driver (Step 504). Until the vehicle engine is started and the electric generator charges the battery up to a second threshold voltage V2 such as 13.0 volts (Step 505), the battery status indicator 822 and the buzzer 826 are then turned off (Step 520).

If the temperature of the washing liquid inside heating pipe is below a first preset value T1, e.g. 65 degrees Celsius (Step 503), the washing liquid in the heating pipe 80 is heated for a first predetermined interval t1, e.g. 4 seconds (Step 506) and then the steps 502, 503 and 506 are repeated. Otherwise, the temperature of the washing liquid is further checked whether greater than first preset value T1 but lower than a second preset value T2, e.g. 80 degrees Celsius (Step 507). Generally, when the temperature is greater than the second preset value, it is indicated that there is not enough washing liquid in the heating pipe 80. Under this circumstance, in response to the control signal from the main control circuit 827, the heating operation is stopped, the water status indicator 823 is turned on, and the buzzer 826 emits warning sounds to alert the driver (Step 508). The drivers should refill water and pump water into the heating pipe until the temperature is reduced less than the second preset value T2, e.g. 80 degrees Celsius (Step 507) so that the water status indicator 823 and the buzzer 826 are turned off (Step 520). If the heating operation fails to be interrupted by the control circuit 827 and the temperature of the heating pipe 80 is greater than the third preset value, e.g. 90 degrees Celsius, a thermostat (not shown) of the de-icing and washing device will switch power of the de-icing and washing device off (Step 511). Otherwise, the steps 502, 503, 506 and 507 are repeated. However, if the temperature keeps increasing up to a fourth preset value T4, e.g. 140 degrees Celsius (Steps 509-510) for some reason, the fuse will be molten to protect the system.

If the temperature of the washing liquid is ranged between the first preset value T1 and the second preset value T2 according to the steps 503 and 507, the heated washing liquid in the heating pipe 80 is ready and available for washing and de-icing the windshield. In response to the control signal from the main control circuit 827, the pump 91 is started to force the washing liquid in the main tank 90 to flow through the heating pipe 80, and the heated washing liquid inside the heating pipe 80, according to Pascal's principle, is forced and sprayed over the windshield for a second predetermined interval t2, e.g. 3 seconds (Step 512).

After the step 512, the temperature of the washing liquid and the voltage of the battery voltage are possibly reduced. If the battery voltage is still greater than the first threshold voltage V1 (Step 513), the heating operation is continued for 1 second (Step 514) to increase the water temperature. If the temperature of the washing liquid is below the first preset value T1 (Step 515), the washing liquid in the heating pipe 80 is continuously heated for a third predetermined interval t3, e.g. 16 seconds (Step 516) and then the steps 513˜516 are repeated. Meanwhile, in response to the control signal from the main control circuit 827, the pump 91 is started to spray the washing liquid over the windshield for 3 seconds while activating the wiper motor 98 to drive the wiper (Step 517). The steps 513˜517 are repeated until the spraying operations are performed for three times (Step 518). Similarly, if the battery voltage or the temperature of the washing liquid is abnormal, the battery status indicator 822 or the water status indicator 823 is turned on, and the buzzer 826 emits warning sounds to alert the driver (Step 519, 508, 509, 504).

From the above description, the driver operation interface of the present de-icing and washing device facilitates a driver to operate the de-icing and washing device. In the automatic mode, if the temperature of the washing liquid sits in a preset range, the pump is started to force the washing liquid in the main tank to flow through the heating pipe, and the heated washing liquid inside the heating pipe is forced and sprayed over the windshield, thereby implementing the washing and de-icing operations. In conclusion, the present invention successfully follows and applies Pascal's principle, which states that an increase in pressure in an enclosed container or system is transmitted uniform-fly to all portions of the system. For example, the pressure created by the pump in the main tank 90 will force the heated washing liquid to spray over the windshield. In addition, since only one pump is required and the piping system is simple, the de-icing and washing device of the present invention is more cost-effective.

In some instances, the de-icing and washing device of the present invention is not applicable to be operated in the automatic mode. As previously described in the step 517, the wiper is driven by the wiper motor 98 to sweep on the windshield when the washing liquid is being sprayed over the windshield. If the ambient temperature is extremely low, the washing liquid being sprayed over the windshield is readily frozen to form a thick ice. Once the wiper touches or strikes the thick ice, the thick ice becomes hindrance from sweeping the wiper on the windshield. Under this circumstance, the wiper is likely deformed or even damaged. Meanwhile, since the load on the wiper motor 98 is abruptly increased, the wiper motor 98 may have a breakdown, too.

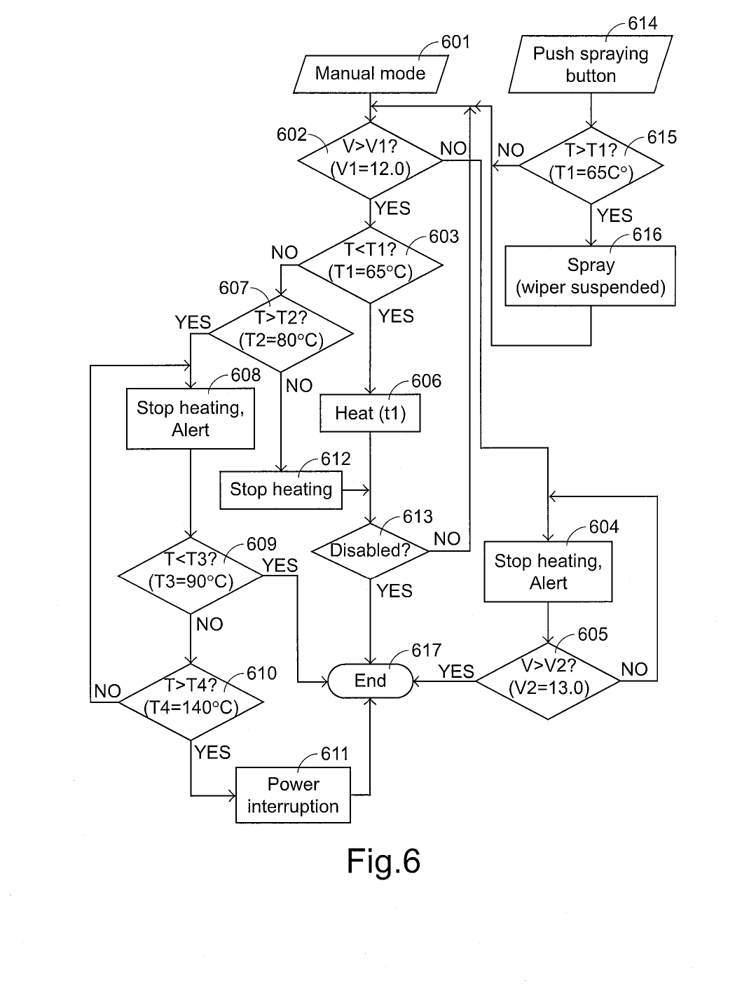

For solving the above problems, it is preferred that the wiper is pulled up instead of resting on the windshield, and a further embodiment of operating the de-icing and washing device according to the present invention is applied, as illustrated with reference to the manual flowchart of FIG. 6.

First of all, a manual mode is entered (Step 601). If the battery voltage V checked by the main control circuit 827 is greater than a first threshold voltage V1 such as 12.0 volts (Step 602). Otherwise, in response to the control signal from the main control circuit 827, the related operations are stopped, the battery status indicator 822 is turned on, and the buzzer 826 emits warning sounds to alert the driver (Step 604). Until the vehicle engine is started and the electric generator charges the battery up to a second threshold voltage V2 such as 13.0 volts (Step 605), the battery status indicator 822 and the buzzer 826 are turned off (Step 617).

If the temperature of the washing liquid is below a first preset value T1, e.g. 65 degrees Celsius (Step 603), the washing liquid in the heating pipe 80 is heated for a first predetermined interval t1, e.g. 1 second (Step 606). Otherwise, the temperature of the washing liquid is further checked whether greater than a second preset value T2, e.g. 80 degrees Celsius (Step 607). Generally, when the temperature is greater than the second preset value, it is indicated that there is not enough washing liquid in the heating pipe 80. Under this circumstance, in response to the control signal from the main control circuit 827, the heating operation is stopped, the water status indicator 823 is turned on, and the buzzer 826 emits warning sounds to alert the driver (Step 608). The drivers should refill water and pump water into the heating pipe until the temperature is less than a second preset value T2, e.g. 80 degrees Celsius (Step 607) so that the water status indicator 823 and the buzzer 826 are turned off (Step 617). If the heating operation fails to be interrupted and the temperature of the heating pipe 80 is greater than a third preset value T3, e.g. 90 degrees Celsius, a thermostat (not shown) of the de-icing and washing device will switch power of the de-icing and washing device off (Step 611). Otherwise, the steps 602-607 and 612-613 are repeated. However, if the temperature keeps increasing up to a fourth preset value T4, e.g. 140 degrees Celsius (Steps 509-510) for some reason, the fuse will be molten to protect the system.

If the temperature of the washing liquid is ranged between the first preset value T1 and the second preset value T2 according to the steps 603 and 607, the heated washing liquid in the heating pipe 80 is ready and available for washing and de-icing the windshield. Under this circumstance, in response to the control signal from the main control circuit 827, the heating operation is stopped (Step 612). If the heating mechanism is not terminated (Step 613), the steps 602˜607, and 612˜613 are repeated.

On the other hand, by pushing the spraying button 821, an interrupt signal is issued from the main control circuit 827 (Step 614). In response to the interrupt signal, the function of the wiper is suspended. If the temperature of the washing liquid is ranged between the first preset value T1 and the second preset value T2, e.g. 65˜80 degrees Celsius (Step 615), the pump 91 is started to force the washing liquid in the main tank 90 to flow through the heating pipe 80, and the heated washing liquid inside the heating pipe 80 is forced and sprayed over the windshield for a time interval e.g. 2 or 3 seconds (Step 616). At this moment, even if the wiper control stick 99 or the wiper motor 98 is activated or the spraying button 821 is pushed, the function of the wiper is kept suspended. Consequently, the possibility of causing damage of the wiper by the frozen ice on the windshield is minimized. In other words, if the ambient temperature is extremely low, the de-icing and washing device of the present invention should be operated in the manual mode so as to suspend the function of the wiper.

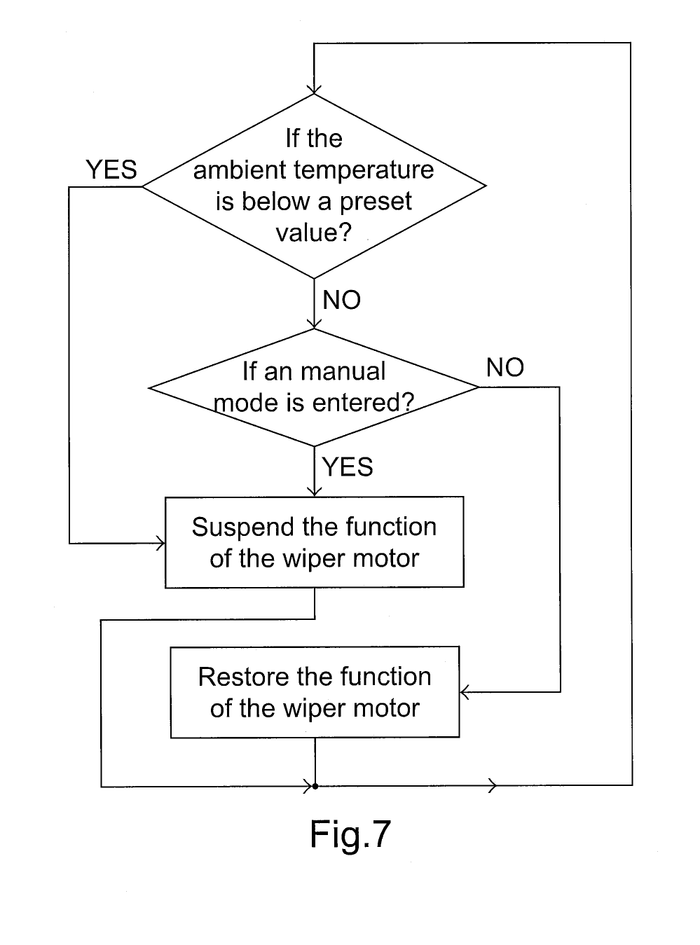

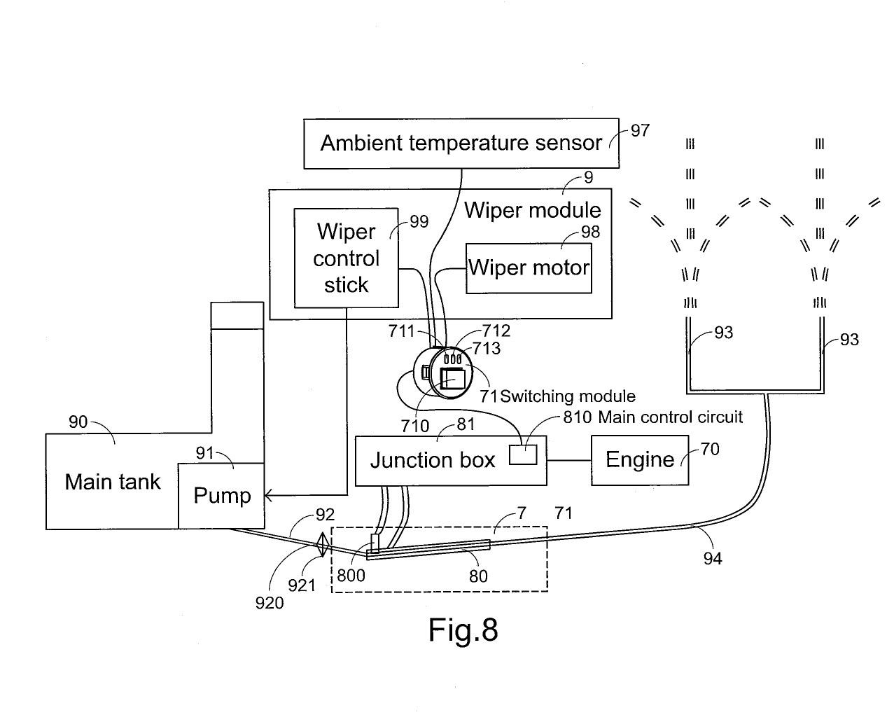

Please refer to FIG. 8 again. The de-icing and washing device of the present invention further comprises an ambient temperature sensor 97. The ambient temperature sensor 97 is electrically connected to the main control circuit 827. For example, the ambient temperature sensor 97 is mounted on the windshield. If the ambient temperature sensed by the ambient temperature sensor 97 is less than a preset temperature (e.g. −10 degrees Celsius), the main control circuit 827 will issue an interrupt signal to suspend the function of the wiper or power off the wiper. At this moment, even if the wiper control stick 99 or the wiper motor 98 is triggered or the spraying button 821 is pushed, the function of the wiper is kept suspended. In contrast, when the ambient temperature is greater than the preset temperature due to the sprayed washing liquid or other reasons, if the de-icing and washing device is operated in the manual mode, the function of the wiper is suspended; or otherwise activated. The criterion of discriminating whether the function of the wiper is suspended or not will be illustrated with reference to FIG. 7. For allowing the wiper to be optionally suspended, the wires for supplying power to the wiper motor can be made separate from the other wires for suspension of the wiper motor and independently controlled via a switch.

Referring to FIG. 8, a schematic architecture of a de-icing and washing device according to another preferred embodiment of the present invention is shown. The de-icing and washing device of the present invention is also applied to for example a vehicle possibly used in frigid zones. The vehicle has been installed therein a main tank 90, a pump 91 in the lower portion of the main tank 90, and a wiper module 9 including a wiper motor 98 and a wiper control stick 99. The de-icing and washing device of this embodiment principally comprises a heating module 7, a switching module 71, a junction box 81 and accessories such as a filter 920 and a one-way valve 921. The filter 920 and the one-way valve 921 are arranged between the main tank 90 and the heating pipe 80 for filtering contaminants from the washing liquid and preventing the washing liquid from flowing back, respectively. The heating module 7 is arranged downstream of the one-way valve 921, and comprises a heating pipe 80 and a temperature sensor 800. A main control circuit 810 is arranged in the junction box 81 for controlling operations of the heating pipe 80 and other circuits of the de-icing and washing device. The heating pipe 80 has a capacity of 100 ml for example. In addition, the heating pipe 80 has a heating mechanism electrically connected to a power supply unit such as a storage battery (not shown) through the junction box 81 after the engine 70 of the vehicle is started. Generally, the washing liquid contained in the heating pipe 80 begins to be heated when the engine 70 is started. The main tank 90 has been stored therein a washing liquid. When the pump 91 is started, the washing liquid is forced to flow through the conduits 92, 94 and spray over the windshield through the nozzle 93.

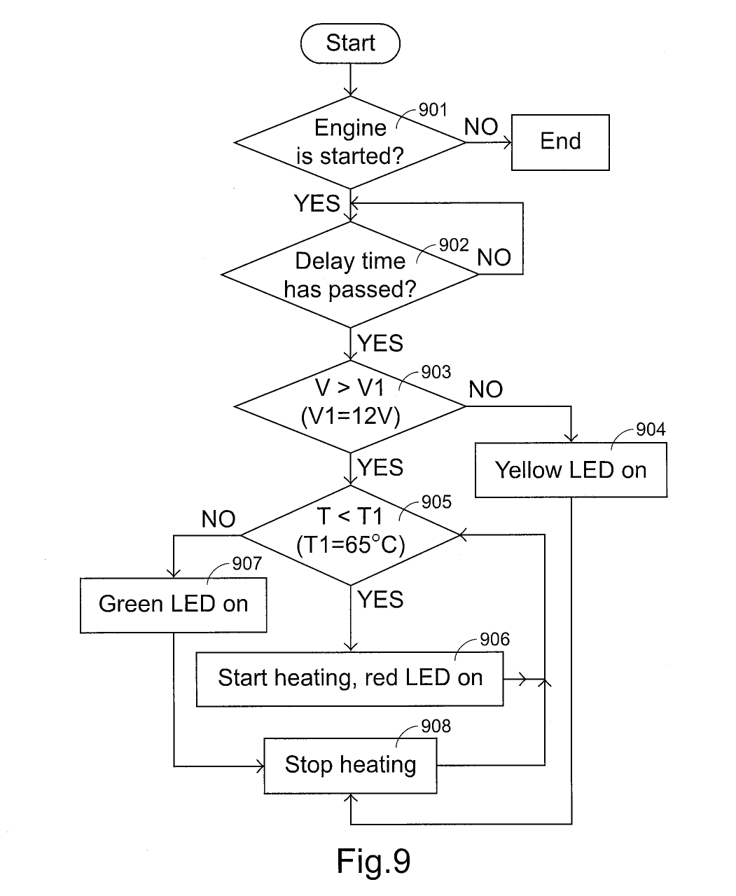

Hereinafter, an embodiment of operating the de-icing and washing device of FIG. 8 will be illustrated with reference to the flowchart of FIG. 9.

First of all, if the main control circuit 810 detects that the engine 70 is started (Step 901) and a delay time (e.g. 10 seconds) has passed (Step 902), the necessary voltage checking procedures start. Since the vehicle power is stable at this moment, if the battery voltage V checked by the main control circuit 827 is greater than a first threshold voltage V1 such as 12.0 volts (Step 903), the power source of the vehicle is suitable to heat the washing liquid. Otherwise, in response to the control signal from the main control circuit 810, the heating procedure is stopped and the battery status indicator 711, said yellow LED, is turned on (Step 904). If the temperature of the washing liquid is below a first preset value T1, e.g. 65 degrees Celsius (Step 905), the washing liquid in the heating pipe 80 is heated for a predetermined interval and the heating status indicator 712, said red LED, is turned on to indicate that the washing liquid in the heating pipe 80 is under heated process (Step 906). After washing liquid is heated, the washing liquid temperature indicator 713, said green LED, is turned on to indicate that the temperature of the washing liquid in the heating pipe 80 is greater than the first preset value T1 (Step 907) and the heating operation is stopped (Step 908).

The switching module 71 includes a push button 710, which is actuated for suspending or restoring the function of the wiper. For example, when the push button 710 is pressed down, the function of the wiper is restored. The wiper becomes normally controlled by vehicle original system. For example, the wiper is driven by the wiper motor 98 to sweep on the windshield when the washing liquid is being sprayed over the windshield. In contrast, once the push button 710 is pressed down again, the function of the wiper is suspended. At this moment, the wiper motor 98 is powered off. Consequently, the wiper motor 98 is not activated by the wiper control stick 99, but the pump 91 is started to force the washing liquid in the main tank 90 to flow through the heating pipe 80 to spray the heated washing liquid over the windshield through the nozzle 93.

In the embodiments, the battery status indicator 711 of the switching module 71 is a yellow light emitting diode, which is turned on to indicate that the vehicular battery is acceptable. For example, if the vehicular battery is greater than 12.0 volts and less than 13.0 volts, a yellow light is on. The heating status indicator 712 of the switching module 71 is a red light emitting diode, which is turned on to indicate that the washing liquid in the heating pipe 80 is under heated process. For example, if the temperature of the washing liquid is below a first preset value T1 (e.g. 65 degrees Celsius), the washing liquid in the heating pipe 80 is heated and a red light is on. When the temperature of the washing liquid is increased up to the first preset value T1, the heating status indicator 712, said red LED, is turned off. The other washing liquid temperature indicator 713 of the switching module 71 is a green light emitting diode, which is turned on to indicate that the washing liquid in the heating pipe 80 is in a preset temperature range and ready for driver's spray. For example, the washing liquid in the heating pipe 80 is between 65 and 80 degrees Celsius, a green light is on. After driver's spray, if the temperature of the washing liquid goes below this preset range, the normal washing liquid temperature indicator 713, said green LED, is turned off and the heating process start again.

As known, if the water level of the main tank 90 is insufficient, the temperature of the washing liquid in the heating pipe 80 may be over-heated and go above a third preset value T3 (e.g. 90 degrees Celsius). For safety, the heater of the de-icing and washing device will be powered off by an equipped thermostat. According to Pascal's principle, which states that an increase in pressure in an enclosed container or system is transmitted uniformly to all portions of the system, the washing liquid will not be sprayed out when the water level of the main tank 90 is insufficient, and there is always some washing liquid left inside the heating pipe 80.

Please refer to FIG. 8 again. The de-icing and washing device optionally comprises an ambient temperature sensor 97. The ambient temperature sensor 97 is electrically connected to the main control circuit 810. For example, the ambient temperature sensor 97 is mounted on the windshield. If the ambient temperature sensed by the ambient temperature sensor 97 is less than a preset temperature (e.g. −10 degrees Celsius), the main control circuit 810 will issue an interrupt signal to suspend the function of the wiper motor. At this moment, even if the wiper control stick 99 or the wiper motor 98 is activated or the spraying button 821 is pushed, the function of the wiper motor is kept suspended but the pump can still be activated by wiper to spray. It is noted that the ambient temperature sensor 97 may be replaced by a snow sensor (not shown). When the snow sensor detects the presence of snow on the windshield, the switching module 71 is automatically switched to suspend the function of the wiper motor.

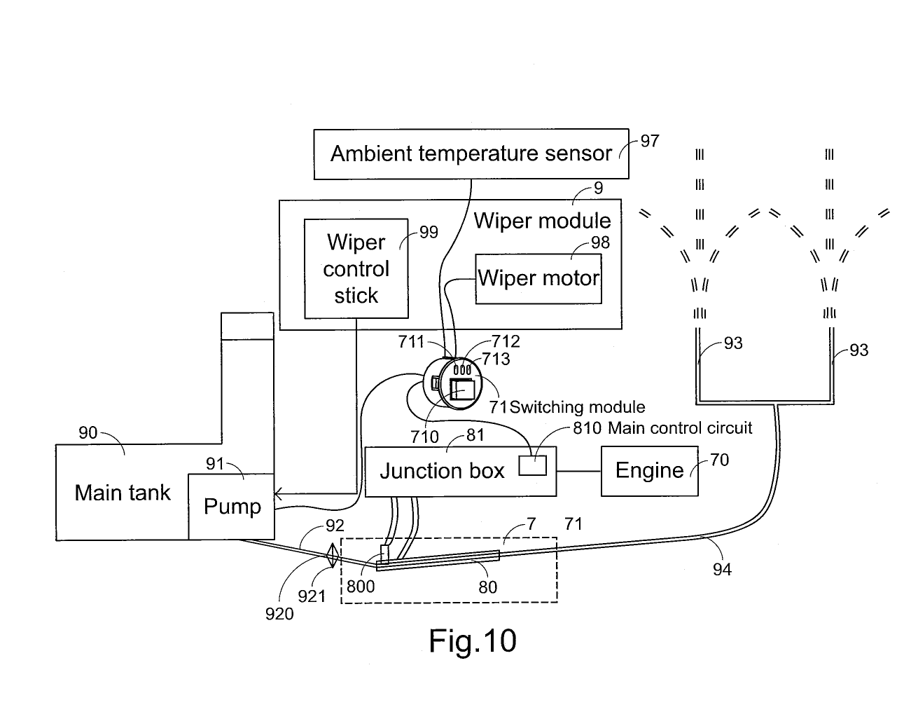

In another wiper control system similar to that of FIG. 8 and executing a control method similar to the flowchart of FIG. 9, the switching module 71 is made electrically connected to the pump 91 so as to control the pump on or off directly, as illustrated in FIG. 10. When the pump is switched on by one push of the switching module 71, the washing liquid can be pumped and sprayed onto the windshield without activating wiper, and when the pump is switched off by one more push switching module 71, the wiper becomes normally controlled by the original wiper system, e.g. when trigger wiper system, it pumps washing liquid to spray over the windshield and wiper swinging afterward as normal and popular system.

To sum up, the wiper control system, pump control system and de-icing and washing method according to the present invention can work well together as described above. Nevertheless, the operation of the entire system can be further improved with the care of the driver. For example, when the driver find the frozen ice and snow is too heavy to be removed by the wiper, the driver can flap up the wiper to stop the wiper from running. Meanwhile, the heating and spraying operations of the washing liquid according to the present invention can still work on the windshield to melt the ice and contaminants. Under this circumstance, the switching module 71 does not operate or can be omitted.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A de-icing and washing device of a vehicle, the vehicle having a main tank storing therein a washing liquid, a pump and a nozzle, the de-icing and washing device comprising:
a heating module in liquid communication between the main tank and the nozzle; and
a control module communicated with the pump and the heating module, and operated in an automatic mode for activating the heating module to heat the washing liquid therein and automatically starting the pump when the temperature of the washing liquid in the heating module is ranged from a first preset value to a second preset value, so that the washing liquid in the main tank is introduced into the heating module, heated by the heating module and sprayed through the nozzle.

2. The de-icing and washing device according to claim 1 wherein the heating module comprises:
a heating pipe for heating the washing liquid; and
a temperature sensor for monitoring the temperature of the washing liquid in the heating pipe.

3. The de-icing and washing device according to claim 1 wherein the control module comprises:
a control box in the vicinity of the driver's seat and including an operation mode switching button thereon; and
a main control circuit electrically connected to the operation mode switching button, the control module and the pump, and operated in the automatic mode when the operation mode switching button is triggered.

4. The de-icing and washing device according to claim 3 wherein the heating module is automatically activated to heat the washing liquid therein when the temperature of the washing liquid in the heating module is less than the first preset value.

5. The de-icing and washing device according to claim 3 wherein the control module further comprises a sound generator, and a warning sound is automatically emitted from the sound generator and the heating operation of the heating module is stopped when the temperature of the washing liquid in the heating module is greater than the second preset value.

6. The de-icing and washing device according to claim 3 wherein the control module further comprises:
a water status indicator enabled to indicate that the water level of the main tank is insufficient;
an automatic mode indicator enabled to indicate that the control module is operated in the automatic mode; and
a battery status indicator enabled to indicate when the output voltage of the battery is lower than a threshold voltage.

7. The de-icing and washing device according to claim 4 wherein the control module is operated in a manual mode when the operation mode switching button is triggered once more.

8. The de-icing and washing device according to claim 7 wherein the control module further comprises a spraying button actuated to start the pump when the temperature of the washing liquid in the heating module is ranged from the first preset value to the second preset value such that the washing liquid in the main tank is introduced into the heating module, heated by the heating module and sprayed through the nozzle.

9. The de-icing and washing device according to claim 1 wherein the control module is communicated with the pump and the heating module via wired signal transmission.

10. The de-icing and washing device according to claim 1 wherein the control module is communicated with the pump and the heating module via wireless signal transmission.

11. The de-icing and washing device according to claim 1 further comprises:
a filter arranged between the main tank and the heating module for filtering contaminants from the washing liquid of the main tank; and
a one-way valve arranged between the main tank and the heating module for preventing the washing liquid from flowing back.

12. A method for de-icing and washing a windshield of a vehicle, the vehicle having a main tank storing therein a washing liquid, a pump, a nozzle, a heating module and a control module, the method comprising steps of:
activating the heating module to heat the washing liquid therein in response to a triggering operation of an actuating button; and
starting the pump when the temperature of the washing liquid in the heating module is ranged from a first preset value to a second preset value, so that the washing liquid in the main tank is introduced into the heating module, heated by the heating module and sprayed through the nozzle.

13. The method according to claim 12 further comprising a step of automatically activating the heating module to heat the washing liquid therein when the temperature of the washing liquid in the heating module is less than the first preset value.

14. The method according to claim 12 further comprising a step of automatically emitting a warning sound and stopping heating operation of the heating module when the temperature of the washing liquid in the heating module is greater than the second preset value.

15. The method according to claim 12 further comprising a step of emitting a warning sound and stopping heating operation when the output voltage of the battery is lower than a first threshold voltage.

16. The method according to claim 15 wherein the warning sound is ended when the output voltage of the battery is increased to a second threshold voltage, which is larger than the first threshold voltage.

17. The method according to claim 12 wherein the pump is automatically started when the actuating button is triggered to enter an automatic mode.

18. The method according to claim 12 wherein the pump is manually started by pushing a spraying button when the actuating button is triggered to enter a manual mode.

19. A de-icing and washing device of a vehicle, the vehicle having a wiper module, a main tank storing therein a washing liquid, a pump and a nozzle, the de-icing and washing device comprising:
a heating module in liquid communication between the main tank and the nozzle; and
a control module communicated with the wiper module, the pump and the heating module, wherein the control module suspends the function of the wiper module in a specified condition but the heating module is activated to heat the washing liquid therein, so that the washing liquid in the main tank is introduced into the heating module, heated by the heating module and sprayed through the nozzle.

20. The de-icing and washing device according to claim 19 wherein the heating module comprises:
a heating pipe for heating the washing liquid; and
a temperature sensor for monitoring the temperature of the washing liquid in the heating pipe.

21. The de-icing and washing device according to claim 19 wherein the control module comprises:
a control box in the vicinity of the driver's seat and including an operation mode switching button thereon; and
a main control circuit electrically connected to the operation mode switching button, the control module and the pump, and operated in an automatic mode when the operation mode switching button is triggered.

22. The de-icing and washing device according to claim 21 wherein the heating module is automatically activated to heat the washing liquid therein in the automatic mode when the temperature of the washing liquid in the heating module is less than the first preset value.

23. The de-icing and washing device according to claim 21 wherein the control module further comprises a sound generator, and a warning sound is automatically emitted from the sound generator and the heating operation of the heating module is stopped when the temperature of the washing liquid in the heating module is greater than the second preset value.

24. The de-icing and washing device according to claim 19 wherein the specified condition is that the ambient temperature of the vehicle is less than a preset temperature.

25. A de-icing and washing device of a vehicle, the vehicle having a wiper module, a main tank storing therein a washing liquid, a pump and a nozzle, the de-icing and washing device comprising:
a heating module in liquid communication between the main tank and the nozzle; and
a switching module actuated to suspend the function of the wiper module but the heating module is activated to heat the washing liquid therein, so that the washing liquid in the main tank is introduced into the heating module, heated by the heating module and sprayed through the nozzle.

26. The de-icing and washing device according to claim 25 wherein the switching module is a push button alternately actuated to suspend the function of the wiper module and restore the function of the wiper module.

27. The de-icing and washing device according to claim 25 wherein the switching module further comprises an ambient temperature sensor, wherein the switching module is actuated to suspend the function of the wiper module when the ambient temperature of the vehicle sensed by the ambient temperature sensor is less than a preset temperature.

28. The de-icing and washing device according to claim 25 wherein the switching module further comprises a snow sensor, wherein the switching module is actuated to suspend the function of the wiper module when the snow sensor senses the presence of a snow on the windshield of the vehicle.

29. The de-icing and washing device according to claim 25 wherein the switching module further comprises:
a yellow light emitting diode indicating the vehicular battery status;
a red yellow light emitting diode indicating the heating status of the heating module; and
a green light emitting diode indicating whether the temperature of the washing liquid in the heating module is in an acceptable range and ready for spray.

30. The de-icing and washing device according to claim 25 wherein the switching module is electrically connected to the wiper module.

31. The de-icing and washing device according to claim 25 wherein the switching module is electrically connected to the pump.
